(19) United States
(12) Patent Application Publication
(10) Pub. No.: US 2004/0056770 A1
(43) Pub. Date: Mar. 25, 2004

(54) Hijack disabling system for commercial aircraft and other vehicles

(76) Inventor: Darrell J. Metcalf, Fillmore, CA (US)

Correspondence Address: Darrell Metcalf, 905 N. Oak Avenue, Fillmore, CA, 93015, US

(21) Appl. No.: 10/246,073

(22) Filed: Sep. 19, 2002

(51) Int. Cl. G08B 13/00

(52) U.S. Cl. 340/574; 701/11; 701/2

(57) ABSTRACT

A system for preventing the hijacking, or suicide-bombing, of aircraft, ocean-going vessels, or trains, having at least one onboard vehicle computer capable of operating the vehicle in an automated transportational mode along at least one path when any attempt to overtake or divert the vehicle is made or suspected, or threat of harm to any vehicle-personnel is made or suspected. The system has at least one signal receiver interfaced with, and having a communication link with, the computer(s), and the computer(s) is configured to be responsive to at least one secure signal when initiated by at least one user aboard the vehicle and sent from at least one signal transmitter to the signal receiver(s). The transmitter(s) has an easy-to-use user-interface which is operated by an engagement of at least one finger of user's hand to cause the signal to be sent to the receiver(s). The computer(s) have at least one software routine which is enabled when the signal is received by the receiver(s) and which causes the computer to operate the vehicle in at least one automated mode. When in the automated mode, all manual control of the vehicle is disabled and the vehicle is automatically directed to a pre-determined programmable destination. The system accommodates a resetting of the computer(s) to a non-automated mode when there is a false deployment and security checks and balances are provided from a secure, independent facility having the means to communicate with those aboard a vehicle and to transmit control signals to the vehicle's system.

### CROSS-REFERENCE TO RELATED APPLICATION

This is a non-provisional patent application, which relies substantially on provisional patent application No. 60/322,904 filed Sep. 17, 2001.

### FIELD OF THE INVENTION

The present invention pertains to security systems and methods for preventing hijackings and suicide-bombings of commercial aircraft and other vehicles such as ships and trains that have the potential to cause great harm when used as ‘guided missiles’ against targets of military, political, strategic and/or social importance. The system incorporates proven computer-automated guidance technology such as Flight Management Computers (“FMC”) and Flight Management Systems (“FMS”) which, in the case of aircraft, are capable of flying and safely landing aircraft in an automated mode. All aircraft used in the suicide-bombing attacks of Sep. 11, 2001 where equipped with FMC/FMS systems. Millions of hours of commercial flight are conducted under automated FMC/FMS flight each year to conserve fuel. In the present invention, one or more vehicle-computers such as a FMC or FMS in the case of aircraft, are interfaced with one or more receivers that receive emergency signals from one or more: (A) compact transmitters transported by vehicle-personnel, (B) surface-mounted transmitters, or (C) transmitters from one or more secure ground-based facility, or other independently-located facility.

### BACKGROUND OF THE INVENTION

The present invention is applicable to the prevention of hijackings or suicide-bombing attacks of commercial aircraft and also applicable to preventing suicide-attacks of vehicles equipped with computer vehicle-guidance systems. For example the hijack disabling system can be employed to prevent attacks using ships laden with LNG, or attacks using trains carrying highly volatile materials. For the purposes of explanation, and in view of the most recent attacks against the United States, the descriptions that follow will focus on the system as applied to commercial aircraft.

Understandably, since the hijackings of 9/11, the airline industry has been struggling to find new ways to increase the confidence of the flying public in the security of commercial aircraft. Their economic survival depends on it. Nonetheless, as long as terrorists believe there is a way to overtake the control of aircraft and wreak horrific acts with the indelible imagery and lasting memories of 9/11 type attacks, they will be highly motivated to repeat aircraft suicide-bombings. However, all of the currently proposed concepts and methods meant to improve commercial aircraft security are merely ‘partial shields’ of one sort or another, which may reduce weapons on planes and aggressive acts committed with those weapons, but no recognized authority in the field of aircraft security has been willing to say that such means are sufficient to cease hijackings or suicide-bombings. Reports of security breaches, where guns are successfully smuggled aboard aircraft (to test screening effectiveness) are not uncommon. No system has yet been proposed to safely and thoroughly preclude hijackings or over-taking of the controls of aircraft. Consequently, terrorists still have much of the same incentive they had prior to 9/11 and the threat of using commercial aircraft as ‘guided missiles’ against strategic and politically-significant targets remains a grave concern.

In a statement published after 9/11 by Physicians for Social Responsibility, the subject of “How Safe are U.S. Nuclear Power Plants?” was explored. The statement said. “As early as 1982, the Argonne National Laboratory, a Department of Energy (DOE) facility, conducted a study detailing the likely damage that a jetliner could inflict on the concrete containment walls protecting nuclear reactors. The study described possible scenarios where an accidental jetliner crash could compromise the safety of a nuclear power plant's primary containment wall and interior structure. The report estimated that even if just 1% of a jetliner's fuel ignited after impact, it would create an explosion equivalent to 1,000 pounds of dynamite inside a reactor building.” A more recent statement cited the following, “The International Atomic Energy Agency (IAEA) has also confirmed that current nuclear power plants are structurally vulnerable against the September 11 attack scenario that destroyed the World Trade Center Buildings.” According to IAEA Spokesman David Kyd, “[Nuclear] Reactors . . . are built to withstand impacts, but not that of a wide-bodied passenger jet full of fuel. A deliberate hit of that sort is something that was never in any scenario at the design stage. These are vulnerable targets and the consequences of a direct hit could be catastrophic.” In an interview with CNN's Moneyline program, Kyd acknowledged that, if such an attack were successfully conducted, “the containment could be breached and the cooling system of the reactor could be impaired to the point where radioactivity might well be set free.”

The report continued: according to experts, if a large airliner were to hit a nuclear power plant's containment structure, the jet engines could penetrate the structure, leading to the introduction within the building of jet fuel and most likely a severe explosion and fire similar to those witnessed at the WTC and the Pentagon on September 11. Nuclear power plants are not well equipped to deal with severe fires, known as “common-mode failures.” Such accidents could actually cause various safety systems to fail simultaneously, leading to a loss of coolant that cannot be mitigated and ultimately resulting in a meltdown of the nuclear fuel.

The report also cited the vulnerability of many reactors to suicide-ship attacks, and the spent fuel pools adjacent to many reactors to suicide-airliner attacks. “The pools contain on the average five times more radioactivity than in the reactor core and constitute collectively the largest concentration of radioactivity on the planet . . . some 40,000 tons of highly radioactive spent fuel. The spent fuel pools at commercial reactors are mostly encased in what the nuclear industry describes as “steel super-structures,” otherwise known as corrugated buildings. The structures protecting commercial spent fuel pools are not as well built as primary containment structures designed to protect reactor cores and are unlikely to withstand a plane crash.”

As long as the possibility of overtaking commercial aircraft remains, and the use of large aircraft as ‘guided missiles’ against ‘targets’ of military, political, strategic and/or social importance is possible, terrorists will be highly motivated to hijack them. Thus, the ‘partial shield’ security approach currently in place, which has been shown to not stop all would-be terrorists, is deficient, and a system that precludes the overtaking of an aircraft and thereby disincentivizes the choice of aircraft as a potential terrorist weapon is needed.

Millions of hours of commercial flight are already flown every year under the automated control of an FMC and/or FMS to improve fuel economy. These systems have the proven ability to fly and safely land large commercial aircraft under their control. In the present invention, this proven ability is be put to use to avert any attempt to use large aircraft for suicide-bombings, and thus can be that has had a credible onboard threat. Thus a system is provided which precludes hijackings and disincentivizes hijackers and/or terrorists by disabling the control of commercial aircraft, or other vehicles, when a hijacking is attempted or suspected, or when the threat of harm to any aircraft, (or other vehicle personnel) is attempted or suspected.

The system includes one or more vehicle-transmitters that are controllable by one or more flight crew/personnel, such as any one or more of the following: pilot, co-pilot, flight engineer, or flight attendant(s), flight marshal, or other vehicle personnel. The vehicle-transmitters are compact in size and is preferably transported by flight crew/personnel and include an easy-to-use user-interface whereby control signal is easily initiated by one or more of the crew/personnel in times of emergency, and the signal is wirelessly transmitted to one or more signal receivers having a communication link with their aircraft's automated flight control system (‘AFCS’). The AFCS includes an interface to receive control signal transmitted from the transmitter(s), and software that 1.) is responsive to the transmitted control signal and 2.) takes control over the aircraft's flight and directs the aircraft to land at an airport or other destination chosen among one or more predetermined and/or programmable choices. Optionally, authorized ground-based or other secure facility personnel can transmit secure and/or encrypted control signal to the vehicle-receiver(s) and/or AFCS to control the aircraft's flight path, or departure path, or approach path, or arrival-airport, or other destination. In the event of a hijacking, pilot or co-pilot control of the aircraft flight is irreversibly disabled upon receiving a control signal(s) and the AFCS controls the aircraft until it touches down. During the landing roll, the pilot can optionally remain in control of a limited number of landing procedures for example, thrust reverser control, and steering/rudder/brake control. Once the plane comes to a stop all operational control of the plane is disabled until reset by authorized security personnel.

Other embodiments of the invention include: A.) one or more TRANSMITTERs that are alternatively, or additionally, surface-mounted at one or more locations throughout the aircraft, in which case the transmitters can be hard-wired to one or more RECEIVERs, or can be surface-mounted wireless transmitters, and B.) a controllable supply of one or more gases suitable for temporarily incapacitating those aboard the aircraft having coupling means for connecting the gas supply to the air supply of the passenger cabin and flight crew cabin. Optionally, the gas supply can provide coupling to allow a ground-based supply of gas(es) the be conveyed into the aircraft after it has landed.

It is noted that although commercial aircraft are specifically addressed in the present invention, that other civilian or military vehicles or vessels may also become the targets of hijackers or become targeted for terrorist purposes, in which case the system described herein can alternatively be employed aboard any one or more of a variety of such vehicles or vessels to safely disable their control by hijackers, including, but not limited to: trains, ships, tanks, buses, trucks, cars, and the like.

It is well-known by specialists in the field of security, that one way to significantly reduce the occurrence of particular crimes, is to significantly reduce the criminal's incentive. For example, following an unprecedented number of robberies occurring at quick-stop markets across the country, it was determined that limiting the amount of cash accessible to an employee at a market would disincentivize the criminal from choosing those types of markets. Specifically, if a robber knew before attempting a crime, that an employee at a market only had access to $20 in change, and that any additional monies were deposited in a vault only accessible by a security person having a matching key, the robber would be much more inclined to choose some other venue. To emphasize that this type of security approach is in place, owners of such markets also make it a point to post notices in plain view of anyone approaching an employee that there is only a limited amount of cash accessible to that employee. The mere posting of such notices (without actual security systems being installed) has also proven to be a deterrent to would-be robbers.

In a similar manner, the AFCS of the present invention disincentivizes would-be hijackers and/or terrorists from aircraft hijackings, by implementing an aircraft security system that securely engages an aircraft's automated flight control system and irreversibly overrides onboard control of aircraft at any point that a hijacking is suspected, or attempted. Thus, by terminating the onboard control of the plane, the system prevents aircraft laden with thousands of gallons of jet fuel from being commandeered as high-speed ‘guided missiles’. The system also precludes any resetting of a hijacked aircraft's AFCS system until one or more authorized personnel located at an arrival-airport boards the landed aircraft and manually resets the system. Thus, the landed aircraft is incapacitated until its system is manually reset.

The system optionally provides for a limited AFCS automation of a flight, for example, a flight departing from a major metropolitan airport can be restricted to fly only a flight path of a particular compass heading, or limited range of degrees proximate to a given compass heading. Once the aircraft has traveled a predetermined number of miles, considered to be a safe distance from the departing airport, the AFCS is either preprogrammed to return control of the aircraft to the pilot, or the RECEIVER and/or AFCS receives secure and/or encrypted control signal that returns the controls of the aircraft to the pilot. In either case, one or more of the pilot's interments indicate the availability of real time flight control and/or a pre-recorded audio message tells the pilot to resume control of the plane. Similarly, the AFCS can be enabled by an appropriate secure and/or encrypted control signal as an aircraft approaches an airport to ensure that the aircraft cannot be diverted away from one or more of the airport's runways. The AFCS can be preprogrammed authorized personnel and/or secure control signal before a flight to provide such automated flight control, and/or be equipped to receive secure and/or encrypted control signal inflight, from one or more transmitter(s) operated by authorized ground-based personnel. In either case, a departure, an approach, and/or flight-path(s) is controllable, verifiable, and irreversibly enabled as needed by control signal sent from one or more transmitters operated by such authorized personnel. Preferably the system includes hardware and software designed to prevent tampering, unauthorized removal of security system components, and/or software hacking.

Such an ability to selectively relinquish, or to programmably, control of an aircraft's flight path (within limited parameters), makes it possible for aircraft equipped with the system of the present invention to depart from and land at airports that are in close proximity to ‘targets’ that would otherwise be inviting, or considered easily accessible, to terrorists. For example, the Reagan National Airport in Washington D.C., is considered so close to the White House, the Pentagon, the Capitol Building and the like, that government officials are suggesting that the airport remain permanently closed. However, with appropriate technological checks and balances, and verifiable means for confirming the implementation of AFCS departures and/or arrivals, such airports could once again function securely with aircraft utilizing the present invention. A related technology is already used aboard aircraft carriers wherein departing jets remain under automated control until a predetermined distance away from the ship, albeit, such automated control of the aircraft is not triggerable by non-pilots aboard the aircraft. Nonetheless, the avionics needed to control departures already exist.

When the cost of permanently shutting down a major national airport is at stake, and aircraft still remain vulnerable to being commandeered as highly volatile ‘guided missiles’, an access to, and control of, an aircraft's AFCS, within limited/authorized conditions, offers a sensible, verifiably secure, and relatively economical solution.

In the wake of the horrific attack on New York city and the Pentagon, several commercial pilots have recently been interviewed to see what they think can be done to thwart hijackings. In one case, a pilot of an air shipping company described an in-flight attack by a disgruntled employee wherein the pilot was able to invert the aircraft to cause the attacker to fall and be restrained by others onboard. Other pilots talked of wanting to be armed and trained to fight onboard terrorists. While such acts by pilots are, or could be, gallant, they are no guarantee that onboard hijackers and/or terrorists will in fact be overcome in their attempts to gain control of an aircraft. Moreover, a failure in stopping a hostile takeover of an aircraft can result in retaliatory acts by the attackers, and/or in gruesome tactics or extortion of one or more flight crew/personnel or passenger(s) in order for the attackers to get their way. By contrast, the present invention provides a hijack disabling system that instantly terminates onboard human control of aircraft immediately following the reception of an authorized control signal. The hijacker and/or terrorist is thereafter unable to do anything to regain control of the aircraft whether the plane is in-flight or on the ground.

Prior to an industry-wide implementation of such a system, a deliberate and thorough media campaign can be initiated using public service announcements, press releases, press conferences, PR, media programming, and commercials and the like, to inform would-be hijackers and/or terrorists that attempting to control and/or commandeer commercial aircraft will cause the aircraft to default to irreversible automated control. Optionally, the campaign can begin as soon as some of the commercial fleet has been equipped with the systems, at which point all aircraft can post public notices of the new AFCS systems, in plain view of boarding passengers, and the would-be hijacker and/or terrorist is left to guess whether or not a given plane actually already has the system installed or not.

During such a campaign, all passengers boarding commercial aircraft can be instructed that any attempt at a hostile overtaking of the aircraft will result in an instant disabling of human flight control input and if the plane is in flight: the initiation of automated flight control and an automated landing, in which case those onboard the aircraft are also informed that the system can only be reset by authorized ground-based personnel. If the flight has yet to depart and hostile control of the plane is attempted, the AFCS is programmed to either A.) remain grounded, or B.) depart and be directed to a predetermined airport, or air base, or other destination.

New commercial aircraft are already equipped with computer-controllable flight systems, capable not only of following a predetermined (or programmable) flight path, but of safely landing such aircraft at commercial airports. The present invention provides a method for:

onboard crew/personnel to transmit a non-reversible control signal to an aircraft's computer-controllable/automated flight control system AFCS;

emergency/MAYDAY-status “Hijack Threat” (‘HJT’) transmission signal to be automatically transmitted from the aircraft to air traffic control facilities and/or other suitable authorized personnel;

onboard automated selection and/or ground based transmitted control signal selection of:

a flight path,

or departure path,

or approach path,

or arrival-airport; and/or other destination

optional audio playback of a pre-recorded message stating that human control of the aircraft has been disabled and optional audio playback stating that the aircraft will safely remain under automated control until after landing, and that control of the aircraft can only be reset by authorized ground-based security personnel located at the arrival airport.

The steps described in the method above can also include real time control signal verification procedures, and real time AFCS status reporting procedures, as well as the status of any implementation pertaining to the pending, or implemented, use of one or more gases aboard the aircraft. In operation, when an aircraft's receiver and/or AFCS receives a transmitted “Hijack Threat” (‘HJT’) signal sent from an onboard electronic transmitter the system instantly and irreversibly engages the AFCS. A real-time AFCS status signal is in turn immediately transmitted via an aircraft-based radio transmitter. The status signal also identifies the particular aircraft (e.g. its aircraft number, and/or flight number and so on). One or more flight controllers on the ground, or other authorized personnel, immediately grant a MAYDAY status to the HJT aircraft, and clearance for its landing at an arrival-airport/destination is given top priority. All aircraft in the vicinity of the HJT aircraft's airspace are diverted safely away from the HJT aircraft.

In one embodiment of the present invention, authorized personnel (not aboard the HJT aircraft), after receiving a HJT signal, can choose among one or more possible destinations for the aircraft, including, in the unfortunate case of biological, chemical, nuclear weapons being aboard the aircraft, of directing the aircraft in a flight path away from populated areas. In each case, the selectable flight path, airport and/or destination, is transmitted back to AFSC of the aircraft using a secure and/or encrypted control signal, and the aircraft's AFSC controls the aircraft accordingly.

In another embodiment, the aircraft is equipped to programmably, or selectively, dispense a supply of one or more gases sufficient in volume, and of a type, to safely incapacitate those onboard the plane. The gas(es) can be automatically triggered upon the initiation of the HJT control signal(s); or delayed after a HJT signal is sent until a predetermined point in the flight; or optionally can be initiated at any point following a transmitted HJT signal by authorized personnel not onboard the aircraft. The gas(es) supply can be onboard, and/or coupled to the aircraft from a ground-based source, and is sufficient in volume to outlast any volume of oxygen that can be hand-carried aboard the aircraft by hijackers and/or terrorists, or any supply that is normally onboard an aircraft.

Thus, it is immediately practicable to implement an effective system that uses compact easily transported transmitters aboard aircraft that can, by simply sending a control signal initiated from the transmitter(s) by one or more authorized crew/personnel, irreversibly disables the control of the aircraft until it has come to a stop on the ground, and optionally and temporarily incapacitates those onboard until the aircraft has been secured by authorized ground personnel.

In view of the destructive power that can be rendered by high speed jets with substantial stores of fuel onboard, and in view of the acceleration of abhorrent terrorist acts around the world, a system that prevents would-be terrorists from gaining control of commercial aircraft and using such aircraft to cause great harm is clearly needed. It is the object of the present invention to provide such a system.

### BRIEF DESCRIPTION OF THE DRAWINGS

FIG. 1 is a diagrammatical flow chart of the hijack disabling system. The dashed rectangle encloses components of the system that are onboard an aircraft. The components below the dashed rectangle are at one or more independent facilities.

FIG. 2 depicts a crew-wearable HJT signal transmitter with user interface and is seen secured to a wrist by a wristband.

FIG. 3 illustrates a crew-wearable HJT signal transmitter with user interface and is seen being worn as a necklace.

FIG. 4 shows a surface-mountable HJT signal transmitter.

### SUMMARY OF THE INVENTION

The present invention is a system for preventing the hijacking, or suicide-bombing, of a transportation vehicle equipped with one or more onboard vehicle-guidance computers capable of operating the vehicle in an automated transportational mode along one or more paths, or routes, or vectors, or railroad lines, including an automated control of the vehicle to and/or terminating at, one or more destinations. The system is comprised of one or more electronic signal receivers, or optical signal receivers, interfaced with, and having a communication link with, the onboard vehicle-guidance computer(s) (e.g. a FMC and FMS in the case of an aircraft). The computer(s) is configured to be responsive to at least one secure electronic or optical signal when initiated by at least one user and sent from at least one electronic signal transmitter to the signal receiver(s). The transmitter(s) have an easy-to-use user-interface which is operated by an engagement of at least one digit of a user's hand to cause the electronic signal to be sent to the receiver(s). The computer(s) have at least one software routine which is enabled when the electronic or optical signal is received by the receiver(s) and which causes the computer to operate the vehicle in one or more automated modes.

The system provides for a positioning of the onboard computer(s) on the vehicle in a secure place, or within a secure, hardened enclosure, or in a place that is inaccessible to anyone conveyed on the vehicle. The electronic or optical signal transmitters are compact in size and are easily carried by hand, or in a pocket, or on a key chain, or transported by the apparel worn by one or more vehicle personnel, or configured as a wearable item such a necklace pendant, or wrist bracelet, to be worn by vehicle personnel, and each of the transmitters is equipped with a signal transmission power sufficient to transmit secure wireless signal from any location on the vehicle, or through apparel worn by vehicle personnel at any location on the vehicle, to the system's electronic signal receiver(s). Alternatively, the transmitters can be configured to be mounted on a surface within a vehicle such that the transmitter(s) is easily accessible to vehicle-personnel and/or passengers aboard an operating vehicle, and each of the transmitters is equipped with a signal transmission power sufficient to transmit secure wireless signal to the electronic signal receiver(s) from any location on the vehicle. The surface mounted transmitter(s) can alternatively have a direct communication link, vie electrical or optical conduit, to the onboard vehicle-guidance computer(s). One or more transmitters can also be equipped with receiver components to function as a transceiver, and one or more receivers can be equipped with transmitter components to function as a transceiver.

Optionally, transmitter(s) and/or receiver(s) can be equipped to capture live video, or display live video, or both, and can be equipped with video imaging, display and transmission means to image, display and transmit live video signal, or receive live video signal, or both.

In other embodiments of the present invention, one or more signal transmitters types are provided and are equipped to communicate secure signal and/or encrypted data to the system's receiver(s) and/or computer(s) such that the latter interpret the signal, or decrypt the data, in amanner that can be sent as machine-readable code to the computer(s) to effect the transportaional mode of the vehicle. In one variant the transmitter can be surface mounted in a fixed position and operate like a typical fire alrm switch, in a second variant the transmitter(s) are surface mounted and removable from the mount such as a GTE Airfone® or other telephone, cell phone type, or telephony device. In a third variant, the transmitter(s) are located at a secure independent facility.

In the fire alram type transmitter variant, one or more electronic signal transmitter is configured to be accessed from a mounting within a vehicle such that the transmitter(s) is easily accessible to one aboard an operating vehicle, and each of the transmitter(s) is further comprised of a mechanism that can be activated during an emergency in a manner similar to that of a pull-down switch typically used to trigger a fire alarm. The transmitter type can be equipped to tranmit signal wirelessly, or via an electrical, or optical, communications link.

In the cell phone variant, the transmitter is configured to be accessed from a mounting within a vehicle such that the transmitter(s) is easily accessible to one aboard an operating vehicle, and each of the transmitter(s) consists of a telephone capable of sending a secure signal to the system's electronic signal receiver(s) and/or computer(s). The receiver(s) is responsive to the secure signal to set the computer(s) into an automated mode. Optionally, the telephone(s) can be configured to operate free of charge when one or more predetermined numbers such as “9”, “1” and “1” on the telephone dial pad are pressed.

Alternatively, the signal transmitter(s) or other switch or user-interface, can be positioned within reach of one sitting in a seat from which, the vehicle is normally controlled.

Preferably, transmitter(s) and the user-interface thereof, are configured to provide an easy-to-use signaling means during an emergency condition wherein a large button of the interface can easily be tactilely felt, discerned and pushed a plurality of times within a predetermined limited amount of time to send a secure signal to the electronic signal receiver(s). For example, pressing the button a minimum of three times within less than two seconds can be required in order to send an emergency signal, this would avoid false deployments that could arise from inadvertantly hitting the button.

Preferably the vehicle's computer(s) has an electronic communication link with an electronic display means to indicate whether the status of a vehicle's computer-guidance system is in an automated mode or non-automated mode. Electronic signal transmitter(s) that are battery powered can be equipped witha battery-energy monitoring and reporting means to indicate battery-energy level status to a user. The battery-energy reporting means can provide sound which is audible to a user to indicate battery energy-level status and/or provide an electronic display which is viewable by a user to indicate battery energy-level status. Also, battery powered transmitters can be equipped with detachable battery chargers.

The vehicle's computer(s) are preferably equipped to handle the reception of signals sent from a plurality of transmitters simultaneously and the computer(s) and software running thereon is responsive to the signals to change the automated mode of the computer(s). The vehicle computer(s) can also be equipped with at least one software routine that prevents any change in the operation of the computer(s) by anyone aboard an operating vehicle, once the computer(s) has been set to the automated mode, in which case, the computer(s) can be programmed so that it can only be reset by at least one authorized security person who boards the vehicle after any threat to a vehicle or to persons aboard a vehicle has been eliminated and the vehicle is deemed safe and secure by authorized security personnel. The vehicle, or onboard, computer(s) are preferably programmed to have at least one ‘false deployment’ software routine that provides for a resetting of the computer(s) from the automated mode to an non-automated mode when, as a result of consultation between one or more flight crew member and one or more flight personnel and/or flight marshal, the flight crew is convinced that a emergency signal was either, sent by mistake, or a threat to the vehicle, has been eliminated. The software of the computer(s) can also be programmed so that ‘false deployment’ software routine(s) can only be executed within a predetermined limited time period following a setting of the computer(s) to the automated mode, for example within a pre-determined limited time period of less than 10 minutes after the computer(s) is set to the automated mode. Additionally, the computer(s) software can be programmed so that the ‘false deployment’ software routine(s) can only be executed after the computer(s) is set to the automated mode and following the reception of subsequent secure electronic signal sent from a plurality of transmitters operated by vehicle-personnel aboard the vehicle. For example, an in-flight procedure can require that one or more, or all, flight personnel assemble after a false deployment, or after an eliminated in-flight threat, to, on a verbal cue, all transmit a post-deployment signal to the computer(s) which resets the computer(s) to a non-automated mode when the signals are received within the pre-determined limited time period (e.g. less than 10 seconds.) As an added precaution, the aircraft can thereafter be closely monitored by one or more independent facility, such that, if there is any diverting of the aircraft exceeding a predetermined time period and no communications from the aircraft regarding such diversion is made, or it is apparent that the aircraft is headed toward a desireable terrorist target, the system will automatically revert to the former automated mode or accept a signal from one or more of the facilities to place the computer into an automated mode. Many aircraft, such as those used in the 9/11 attacks, have a FMC and/or FMS and have fly-by-wire flight controls capable of disabling human/manual input from within the cockpit, the system of the present invention overrides cockpit flight control when the aircraft is in an automated mode.

The hijack disabling system preferably provides an independent secure facility, such as a ground-based facility, or a mobile facility such as a facility onboard a ship or aircraft. The facility has one or more secure-signal facility-transmitter for transmitting secure signal to the vehicle. The vehicle has one or more vehicle-receivers for receiving transmitted secure-signal sent from the secure facility. The vehicle-receiver(s) have a communications link with the vehicle's guidance computer(s), and the combination of the computer(s) and software running thereon are responsive to transmitted secure signal to effect the transportational mode of the vehicle. The vehicle computer(s) have one or more ‘false deployment’ software routine that can only be executed following the reception of a secure electronic signal sent from the facility-transmitter(s) to the vehicle-receiver(s). The computer(s) can be programmed to have at least one software routine for selecting at least one automated vehicle route, and/or at least one vehicle destination, in response to the reception of a secure electronic signal sent from one or more secure facility-transmitter to the vehicle-receiver. For example, after a hijacking occurs, it may be claimed that an aircraft has a nuclear, or biological, device aboard, it which case, the aircraft can be diverted from its scheduled flight-path and diverted according to a secure facility-transmitted signal, to a destination away from populated areas, for example a deserted, or seldom used, air field, or closed military air base. In other instances, it may also be preferable to divert an aircraft from its scheduled flight-path according to a facility-transmitted signal, for example, if there is a depressurization of the aircraft cabin, or the aircraft is clearly being diverted off course with no explanation, or for some other exigency, and the aircraft needs to be landed quickly or otherwise independently controlled. The secure facility-transmitted signal can include encrypted data in which case, the system is further comprised of onboard decryption means aboard the vehicle to decrypt the encrypted data.

The independent facilities and vehicles can also be equipped with additional communications and security-enhancing apparatus. For example, at least one secure facility independent of the vehicle, can have at least one secure-signal facility-transmitter for transmitting secure signal to the vehicle. The vehicle can have at least one vehicle-transmitter suitable for establishing a communications link with a facility-receiver at the facility. The vehicle can have at least one vehicle-receiver for receiving transmitted secure-signal sent from the secure facility, and the computer(s) can have at least one software routine responsive to the secure electronic signal when sent from the secure-signal facility-transmitter to the vehicle-receiver to effect the transportational mode of the vehicle. Additionally, the vehicle and the facility(s) can be equipped with bi-directional voice communication means for conducting voice communications between at least one person at the secure facility(s) and at least one person aboard the operating vehicle. The secure facility(s) can also be equipped with a voice-stress analysis system capable of providing voice-stress analysis of the person(s) aboard the operating vehicle and reporting atypical stress in the human voice, and the computer(s) can be equipped with at least one software routine responsive to the secure electronic signal having data pertaining to the voice-stress analysis when sent from the secure-signal facility-transmitter. The bi-directional voice communication can be limited to a pre-determined time period such as, less than 10 contiguous minutes, to preclude any attempt by one or more hijacker aboard a vehicle to negotiate a desired outcome. Communication between at least one person at a secure ground-based facility and at least one person aboard an operating vehicle can be further comprised of a video imaging means for transmitting live video of the at least one person aboard an operating vehicleto said facility, and can include video transmission means to transmit live video of the at least one person at the facility to at least one person aboard an operating vehicle. Preferably, the secure facility has security provided by at least one branch of the military, and may also be operated by at least one branch of the military.

The vehicle computer(s) when the vehicle is an aircraft, can include one or more flight management computer “FMC”, and/or one or more flight management system “FMS.” The vehicle computer(s) are equipped to be programmed, or receive secure transmitted signal, having vehicle-directing/control data including, but not limited to, any one or more of the following: navigational routes, flight vectors, destinations, railroad routes, vehicle speeds, altitude settings, attitude settings, vehicle thrust, vehicle engine speed, vehicle flap or other moving surface(s) settings, landing or flight configurations, vehicle braking, vehicle or vessel rudder settings, vehicle engine on or off settings, any or all of which are programmable in, or can be received by, and are executable by, a vehicle computer(s) as needed. The computer(s) can also be programmed to fly an aircraft at a safe altitude and along one or more safe courses in the event of a depressurization of the aircraft cabin.

The transmitter(s) can optionally be equipped with voice transmission means to send at least one voice activation signal to the receiver(s) and the receiver(s) having voice-recognition and analog to digital conversion means to convert the signal into data that can be executed by the computer(s).

Each secure, independent facility(s) is equipped to grant “top priority status” to a moving vehicle under automated computer control, to clear all other like vehicles out of its way on any route the vehicle takes and to any destination it goes to, and the facility is also equipped with communications means to contact any transportation-related and security entity necessary to notify them of the vehicle's status and the type of threat the vehicle poses. Vehicle computer(s) are optionally equipped to be programmed to automatically set a vehicle into an automated mode if the vehicle is diverted from a expected path for longer than a predetermined threshold time period and when no communication from the vehicle has been made during the alloted time period. For example, if an aircraft is diverted significantlly off course, or is significantly changing its altitude, for more than a preset number of minutes and no communication from the aircraft flight crew explaining its actions is received, the computer(s) can set the aircraft in an automated flight mode and disable in-cockpit human flight control. Similarly, if the vehicle is not sending transponder signal for longer than a predetermined threshold time period and when no communication from the vehicle has been made during the time period the computer(s) can set the aircraft in an automated flight mode and disable in-cockpit human flight control.

In the event that a vehicle, such as a commercial aircraft is guided in an automated mode to a pre-determined destination, and a hostile or threatening condition still exists aboard the aircraft, an embodiment of the hijack disabling system provides for equipping aircraft with at least one orifice and coupling means for coupling one end of a gas conduit thereto, and providing a supply of at least one incapacitating gas having a gas outlet and coupling means for coupling an opposite end of the gas conduit thereto, and control means for controlling the flow of the gas through the conduit into the vehicle as needed. When needed, the gas is conveyed through the gas conduit into the orafice which in turn, is coupled to least one gas outlet leading to the aircraft cabin. Those aboard the aircraft become incapacitatedd when the volume of the gas relative to the normal volume of air in the cabin reaches a known threshold.

Optionally, the vehicle computer(s) can be programmed and have a user interface to provide for, the entering of a transportation mode change access code to revert the computer(s) from an automated mode to a non-automated mode when a crew member controlling the vehicle is convinced after conferring with a plurality of vehicle personnel that a “false deployment” mistakenly sent by at least one vehicle personnel has caused the vehicle to enter an automated mode, or when an onboard threat has been successfully eliminated. The computer(s) can also be programmed to automatically set the vehicle back into an automated mode after an access code is entered, if the vehicle is diverted from a expected path for longer than a predetermined threshold time period and when no communication from the vehicle has been made during the time period.

The hijack disabling system also provides methods for preventing the hijacking, or suicide-bombing, of a transportation vehicle equipped with at least one onboard computer capable of operating the vehicle in an automated transportational mode along at least one path, the method comprising the steps of:

a) entering vehicle path data and vehicle destination data into the computer(s) before the vehicle departs;

b) equipping the vehicle with at least one signal-receiver interfaced with, and having a communication link with, the computer(s) such that the computer(s) is configured to be responsive to at least one secure signal when initiated by at least vehicle personnel-user and sent from at least one signal transmitter to the signal receiver(s);

c) equipping a plurality of the vehicle personnel-users with the transmitter(s) having an easy-to-use user-interface during a time of emergency;

d) operating the transmitters as needed by an engagement of at least one digit of a user's hand to cause the signal to be sent to the receiver(s);

e) equipping the computer(s) with at least one software routine which is enabled when the signal is received by the receiver(s) and which causes the computer to operate the vehicle in at least one automated mode; and

f) transmitting vehicle transportation mode status to proper authorities when a vehicle enters a system-automated mode.

The previous method of preventing the vehicle hijacking and suicide-bombing can be optionally enhanced when further comprising the steps of:

a) audibly informing those aboard the vehicle that the vehicle is equipped with a computerized vehicle control system capable of safely controlling the vehicle in case of an emergency,

b) audibly informing those aboard that if any attempt to overtake or divert the vehicle is made or suspected, or threat of harm to any vehicle-personnel is made or suspected, all manual control of the vehicle will be disabled and the vehicle will be directed to automatically and safely go to at a pre-determined destination. After stopping, the vehicle will remain disabled and cannot be moved until authorized security personnel board the vehicle, remove any security threat, remove everyone from the vehicle, and after the vehicle is emptied, manually reset the vehicle computer.

Alternatively, the previous method of preventing the vehicle hijacking and suicide-bombing can be further enhanced when also comprising the steps of:

a) informing those who intend to board the vehicle in writing that the vehicle is equipped with a computerized vehicle control system capable of safely controlling the vehicle in case of an emergency,

b) informing those who intend to board the vehicle in writing that if any attempt to overtake or divert the vehicle is made or suspected, or threat of harm to any vehicle-personnel is made or suspected, all manual control of the vehicle will be disabled and the vehicle will be directed to automatically and safely go to at a pre-determined destination. After stopping, the vehicle will remain disabled and cannot be moved until authorized security personnel board the vehicle, remove any security threat, remove everyone from the vehicle, and after the vehicle is emptied, manually reset the vehicle computer.

### DETAILED DESCRIPTION OF THE DRAWINGS

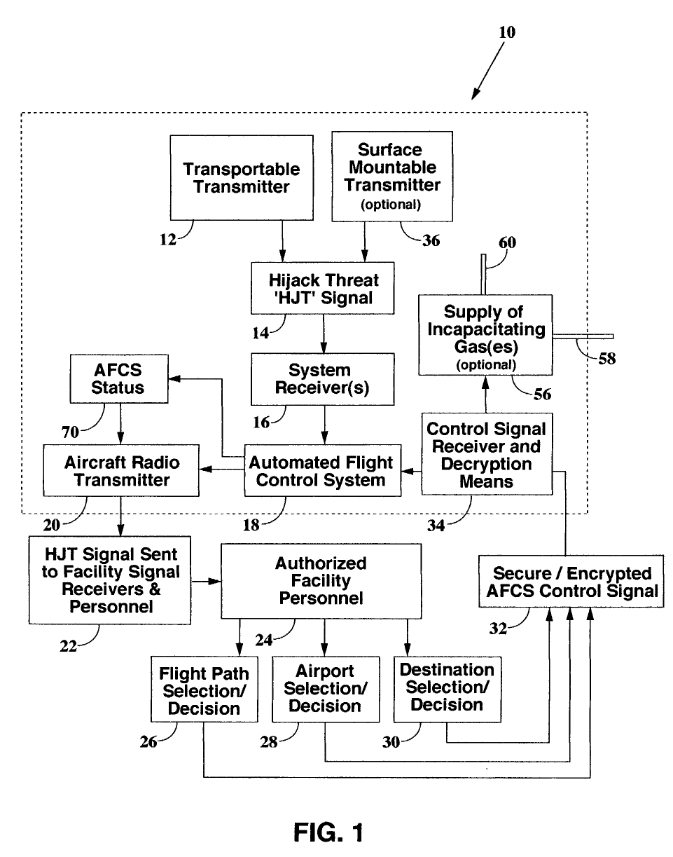

In reference to FIG. 1, a hijack disabling system 10 is shown comprised of apparatus whereby flight crew or flight personnel such as a pilot, or co-pilot, or flight engineer, or one or more flight attendants or flight marshals, aboard an operating aircraft, can easily initiate a secure and/or encrypted “Hijack-Threat” (‘HJT’) control signal from a transportable transmitter 12 or a surface mountable transmitter 36. The transportable transmitters are made with an easy-to-use interface and have a simple operation similar to that of a small garage door opener-transmitter. The surface mountable transmitters are made with an easy-to-use interface and have a simple operation similar to that of a typical wall-mounted fire alarm switch. When a hijacking is attempted or suspected, or when the threat of harm to any aircraft personnel is attempted suspected, or made, one or more users can simply press a button on the transmitter user-interface to send a HJT signal to one or more system receiver(s) 16 interfaced with one or more aircraft-guidance computer(s) the latter hereinafter referred to as “automated flight control system” or “AFCS”. The receiver(s) 16 has a communication link with the AFCS . When the receiver receives a HJT signal from the transmitter(s) 12 the signal is converted into machine-readable code and sent to the AFCS 18. To prevent tampering or damage to the AFCS 18, the AFCS can alternatively be positioned within a hardened enclosure, or positioned in the aircraft in a location that is inaccessible to those aboard the aircraft when it is in operation. In FIG. 1, transmitter 12 is depicted as ‘transportable’ however, it is noted that an optional surface mountable transmitter 36 is also shown in FIGS. 1 and 4 and can alternatively, or additionally, be mounted on one or more surfaces throughout an airplane. In each case, the transmitters 12 have an easy-to-use interface 52 that is readily accessible to onboard crew/personnel. For example, the interface can consist of a simple electronic push button that is easily reached and activated when needed. To avoid unintentional activation of a transmitter push button, the transmitters 12 can be configured to require a certain sequence, and/or a rapid succession of, button-pushes. For example, a user may be required to push the button at least three times within a one-second time span. Optionally, any transmitter can also be equipped with a AFCS-status indicator such as one or more light, or LED, or the like, to indicate that a HJT control signal has been sent. Subsequent transmissions other than HJT signals are optionally possible wherein the transmitter can be equipped with voice transmission and/or voice-messaging capabilities, and when equipped for bi-directional communications, can have voice reception capability. Alternatively, a predetermined sequence of button pushes, following a HJT signal, could be employed to indicate other pertinent information. In any case, the transmitter can optionally provide valuable additional information following a HJT control signal transmission e.g. how many hijackers are onboard, what type of threat is being made, how many people have been, or are about to be, harmed, and so forth.

Transmitters 12 or 36 are comprised of the user interface and preferably have one or more intelligent controller and control circuitry and wearable variants (12) are powered by an internal power supply. Optionally, the circuitry can also include a chronograph that ‘time-stamps’ the time and date of any transmissions received by he AFCS. The transmitters have at least one uni-directional, or bidirectional, control signal transmission means such as any one or more of a variety of transmitter types, or transceiver types, that are available to the military, or available from commercial electronic suppliers. Additionally, the transmitter(s), or transceiver(s), can be configured for establishing any one or more of a variety of secure communications links, or communications protocols, including, but not limited to the following types of communications: radio frequency transmissions and/or receptions, LANs, WANs, Bluetooth, 811.x, IR, hard-wired connections, optical connections/transmissions, Ethernet, cellular, satellite, Internet networks, and the like.

The transmitters 12 and/or 36 are comprised of electronic circuitry and components sufficient to transmit, when activated by crew/personnel, a HJT Signal 14 from any location on an airplane to one or more system receivers 16 located elsewhere on the aircraft. In another embodiment, the surface mountable transmitters can include cell phones such as GTE's Airfonee that are surface mounted on the back of aircraft passenger seats and at least one of system receiver(s) 16 is equipped to receive signal from the cell phones. Additionally, the cell phones can be configured to allow a dialing of an emergency number such as “9”, “1”, “1” for free, without having to use a credit card, and the predetermined number when dialed serves as a HJT control signal.

In another embodiment, the surface mountable transmitters can include cell phones such as GTE's Airfone® that are surface mounted on the back of aircraft passenger seats and at least one of system receiver(s) 16 is equipped to receive signal from the cell phones. Additionally, the cell phones can be configured to allow a dialing of an emergency number such as “9”, “1”, “1” for free, without having to use a credit card, and the predetermined number when dialed serves as a HST control signal.

In another embodiment, the transmitters can include one or more communications device located at an independent secure facility such as a facility at, or guarded by, one or more military branch, or a facility aboard a military vessel or aircraft. In this embodiment, the commercial aircraft is also equipped with one or more receivers 34 interfaced with the AFCS of the aircraft and receive signal when sent from the independent facility and convey such signal to the AFCS in a machine-readable code format.

Preferably, the system transmitter(s) are equipped to send a secure signal and/or encrypted data to their respective system receiver(s) and the latter is equipped to decrypt any encrypted data it receives.

The system receivers 16 are preferably comprised of one or more intelligent controller and control circuitry and are powered by a power supply, and have at least one uni-directional reception means, or bi-directional transmission and reception means, such as any one or more of a variety of receiver, or transceiver types, that are made available to the military, or are available from commercial electronic suppliers. In either case, the system receivers 16 have transmitter-signal reception circuitry and components suitable for receiving HJT Control Signal 14 initiated by any transmitter-equipped crew/personnel aboard the aircraft, and intelligent controller means and software for controlling the AFCS according to one or more received HJT control signals.

The hijack disabling system of the present invention is intended to be a failsafe system in respect to disabling any onboard human control of the aircraft while in operation. Thus, if any crew/personnel aboard a system-equipped aircraft initiates a HJT control signal, the control of the aircraft is immediately turned over to an onboard ‘Automated Flight Control System’ 18 (‘AFCS’) such as those employed to automatically fly an aircraft along a particular flight path or route, and/or those employed to automatically land an aircraft at a predetermined, or programmable destination. As mentioned above, the AFCS of the present invention is equipped with suitable electronic hardware, and software, to receive and be responsive to, HJT control signal 14 sent by one or more transmitters 12 and received by one or more receivers 16. Upon reception of one or more signal 14, the AFCS switches the AFCS-State 70 to positive state and activates a aircraft radio transmitter 20, to send an ‘Hijack Threat’ HJT signal to one or more facility signal receivers and personnel 22 to alert authorized facility personnel 24 that a hostile overtaking of the aircraft has occurred. The aircraft can be automatically routed by one or more secure ground based computer-controllable routing systems (not shown), or in another embodiment of the present invention, can be routed, optionally within a predetermined period of time following a HJT signal, by authorized ground-based personnel 24 such as an authorized flight controller, or other authorized agent. For added security purposes the predetermined period of time can be limited to a few minutes. Only authorized personnel 124 have access to, and control of, electronic transmission equipment for sending secure and/or encrypted AFCS control signal, hereinafter referred to as secure/encrypted AFCS control signal 32, to a hijacked aircraft. The authorized ground-based personnel have one or more selection of flight path, airport, or destination, as represented in FIG. 1: flight path selection/decision 26, airport selection/decision 28, and destination selection/decision 30. The flight path selection/decision 26 can optionally include limited flight path control, for example if a HJT has not occurred, it can still be advantageous, as previously described, to control an aircraft's departure path, or approach path, in which case authorized facility personnel control the aircraft's AFCS for a limited time. Additionally, it can also advantageous to have a controllable supply of incapacitating gas(es) 56 wherein the controllable supply is responsive to control signal sent from AFCS 18 or from secure/encrypted AFCS control signal 32. In FIG. 1, the supply 56 is shown having a gas outlet 60 that is coupled to an air inlet leading to the passenger cabin and optionally also leads into the flight crew quarters. The supply optionally includes a gas-inlet coupling means 58 whereby one or more gases from a ground-based supply can be coupled to the aircraft and controlled by authorized ground-based personnel, Preferably, the flight control signal 32 is securely encrypted in which case, decryption means, hereinafter referred to as control signal receiver and decryption means 34 is also included aboard the aircraft to receive and decrypt secure radio transmissions. Following the transmission and/or decryption of any transmitted signal 32, the AFCS controls the aircraft according to selection(s)/decision(s) that are securely transmitted.

In operation, the apparatus of the present invention is implemented in a sequence of steps which define a method. The first step is taken when one or more flight crew/personnel aboard an aircraft determines that a hostile takeover of the aircraft is occurring, or is about to occur. The second step consists of the crew/personnel activating the user interface of the transmitter 12 in a predetermined, or programmable, manner to send a HJT control signal 14 to one or more onboard system receivers 16. Thirdly, the system receivers 16 are electronically linked to the AFCS 18 and upon receiving a HJT control signal , the AFCS immediately takes control over the aircraft's flight control systems. Fourthly, HJT signals indicating a change in HJT-Status and clearly identifying the aircraft are sent to facility signal receivers and personnel 22, and optionally audio playback means are activated to playback a pre-recorded message informing all onboard the aircraft that, for their safety, the control of the aircraft has been safely turned over to the AFCS. This message can optionally include a statement assuring the passengers that the aircraft is equipped to fly and land safely under automated flight control. It is noted that although the audio playback means is not shown, that any one or more in a variety analog, or digital, playback means can be employed and electronically linked with the system to receive message playback initiating signal(s) which in turn causes the playback of one or more audio recordings after a HJT signal has been received by the system. Such audio playback means can be electronically linked with the aircraft's existing audio system. Next, the alerted authorized facility personnel 24 are either notified as to the aircraft's automated flight path, automated arrival airport or automated destination, or optionally the personnel 24 determine and transmit control signal which dictates an automated flight path, automated arrival airport or automated destination.

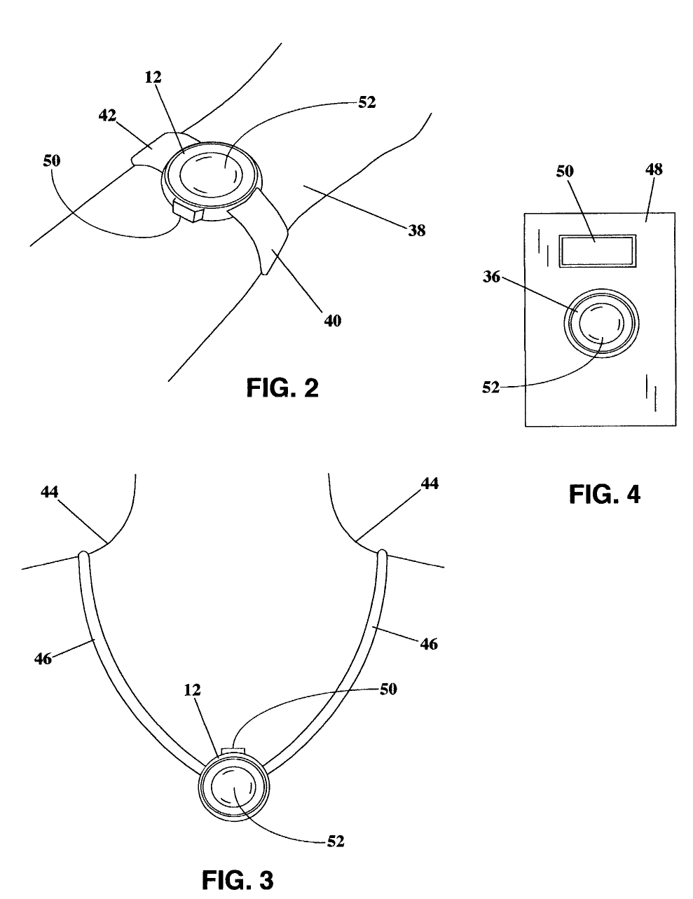

FIGS. 2 and 3 illustrate that a variety of wearable transmitters, or transceivers are easily provided. It is noted that although the transmitters 12 are depicted as being retained by a wristband and necklace respectively, that any number of wearable variants are possible for example, a shirt, or blouse, or lapel mounted transmitter, or belt, or pocket mounted or retained transmitter, and the like. Likewise, the surface-mounted transmitter, or transceiver, of FIG. 4 is shown mounted on a vertical surface having at least one HJT-Status indicator 50, however it is noted that the surface mounting of the apparatus could instead be mounted on any non-vertical surface.

Transmitters 12 or 36 are equipped with software allowing authorized personnel to reset the apparatus after a HJT control signal has been sent. In one variant of the device, the reset procedure is performed using a predetermined sequence of button pushes. In another variant, a control signal sent from a AFCS-linked system receiver/transceiver is employed to reset one or more transmitter 16.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the specification and any claims to follow.

1. A system for preventing the hijacking, or suicide-bombing, of a transportation vehicle equipped with at least one onboard computer capable of operating said vehicle in an automated transportational mode along at least one path, said system comprising:
at least one electronic signal receiver interfaced with, and having a communication link
with, said computer(s);
said computer(s) configured to be responsive to at least one secure electronic signal when initiated by at least one user and sent from at least one electronic signal transmitter to said signal receiver(s);
said transmitter(s) having an easy-to-use user-interface which is operated by an engagement of at least one digit of a user's hand to cause said electronic signal to be sent to said receiver(s);
said computer(s) having at least one software routine which is enabled when said signal is received by said receiver(s) and which causes the computer to operate the vehicle in at least one automated mode.

2. The system of claim 1 further comprising a positioning of said onboard computer(s) on said vehicle in a secure place.

3. The system of claim 1 further comprising a positioning of said onboard computer(s) on said vehicle within a secure, hardened enclosure.

4. The system of claim 1 further comprising a positioning of said onboard computer(s) on said vehicle in a secure place that is inaccessible to anyone conveyed on said vehicle.

5. The system of claim 1 wherein at least one of said electronic signal transmitters is compact in size and easily transported by apparel worn by at least one vehicle personnel, and each of said transmitters is equipped with a signal transmission power sufficient to transmit secure wireless signal through said apparel to said electronic signal receiver(s) from any location on said vehicle.

6. The system of claim 1 wherein said electronic signal transmitter(s) is compact in size and is configured as a wearable item to worn by vehicle personnel, and each of said transmitters is equipped with a signal transmission power sufficient to transmit secure wireless signal to said electronic signal receiver(s) from any location on said vehicle.

7. The system of claim 1 wherein said electronic signal transmitter(s) is transportable by at least one vehicle personnel, and is equipped with a signal transmission power sufficient to transmit secure wireless signal to said electronic signal receiver(s) from any location on said vehicle.

8. The system of claim 1 wherein said at least one electronic signal transmitter is configured to be mounted on a surface within a vehicle such that the transmitter(s) is easily accessible to vehicle-personnel aboard an operating vehicle, and each of said transmitters is equipped with a signal transmission power sufficient to transmit secure wireless signal to said electronic signal receiver(s) from any location on said vehicle.

9. The system of claim 1 wherein said at least one electronic signal transmitter is configured to be mounted on a surface within a vehicle such that the transmitter(s) is easily accessible to one aboard an operating vehicle, and each of said transmitters is equipped with a signal transmission power sufficient to transmit secure wireless signal to said electronic signal receiver(s) from any location on said vehicle.

10. The system of claim 1 wherein said at least one electronic signal transmitter is configured to be mounted on a surface within a vehicle such that the transmitter(s) is easily accessible to one aboard an operating vehicle, and said transmitter(s) is electrically connected with said electronic signal receiver(s) by electrical conduit.

11. The system of claim 1 wherein said at least one electronic signal transmitter is configured to be mounted on a surface within a vehicle such that the transmitter(s) is easily accessible to one aboard an operating vehicle, and said transmitter(s) is connected with said electronic signal receiver(s) by optical conduit.

12. The system of claim 1 wherein said at least one electronic signal transmitter is further comprised of a video capture and transmission means suitable for capturing and transmitting a secure, live video transmission of a user.

13. The system of claim 1 wherein said at least one electronic signal transmitter is further comprised of a video imaging and display means suitable for receiving and displaying a live video transmission on a video display of said transmitter.

14. The system of claim 1 wherein said at least one electronic signal receiver is further comprised of a video imaging and display means suitable for receiving and displaying a live video transmission on a video display of said transmitter.

15. The system of claim 1 wherein said at least one electronic signal transmitter is configured to be accessed from a mounting within a vehicle such that the transmitter(s) is easily accessible to one aboard an operating vehicle, and each of said transmitter(s) consists of a telephone capable of sending a secure signal to said electronic signal receiver(s), and said receiver(s) is responsive to said secure signal to set said computer(s) into an automated mode.

16. The system of claim 12 further comprising said telephone(s) configured to send said secure signal to said electronic signal receiver(s) and to operate free of charge when the numbers “9”, “1” and “1” on the telephone dial pad are pressed.

17. The system of claim 1 wherein said at least one electronic signal transmitter is configured to be accessed from a mounting within a vehicle such that the transmitter(s) is easily accessible to one aboard an operating vehicle, and each of said transmitter(s) is further comprised of a mechanism that can be activated during an emergency in a manner similar to that of a pull-down switch typically used to trigger a fire alarm.

18. The system of claim 1 wherein said electronic signal transmitter(s) is within reach of one sitting in a seat from which, said vehicle is normally controlled.

19. The system of claim 1 wherein said electronic signal receiver(s) is further comprised of an easy-to-use user-interface which is operable by one or more digits of a user's hand to cause a secure electronic signal to be sent to said computer(s), and said interface is within reach of one sitting in a seat from which, said vehicle is normally controlled.

20. The system of claim 1 wherein said electronic signal transmitter(s) and said user-interface are configured to provide an easy-to-use signaling means during an emergency condition wherein a large button of the interface can easily be tactilely felt, discerned and pushed a plurality of times within a predetermined limited amount of time to send a secure signal to said electronic signal receiver(s).

21. The system of claim 1 further comprising an electronic display means which is electronically linked with said computer(s) to indicate whether or not a vehicle is in an automated mode.

22. The system of claim 1 wherein said electronic signal transmitter(s) is battery powered and has a battery-energy monitoring and reporting means to indicate battery-energy level status to a user.

23. The system of claim 22 wherein said reporting means is equipped to provide sound which is audible to a user to indicate battery energy-level status.

24. The system of claim 22 wherein said reporting means is further comprised of an electronic display which is viewable by a user to indicate battery energy-level status.

25. The system of claim 1 wherein said electronic signal receiver(s) is equipped to handle the reception of signals sent from a plurality of transmitters simultaneously and said computer(s) and software running thereon is responsive to said signals to change the automated mode status of said computer(s).

26. The system of claim 1 wherein said transmitter(s) is further comprised of a video imaging means for transmitting live video of at least one person aboard an operating vehicle, and said receiver(s) is further comprised of a video imaging and displaying means for displaying a video image of said at least one person.

27. The system of claim 1 wherein said transmitter(s) is further comprised of a secure signal receiver components and operates as a transceiver.

28. The system of claim 1 wherein said receiver(s) is further comprised of a secure signal transmitter components and operates as a transceiver.

29

30. The system of claim 1 further comprising said onboard computer(s) having at least one software routine that prevents any change in the operation of the computer(s) by anyone aboard an operating vehicle, once said computer(s) has been set to said automated mode.

31. The system of claim 29 wherein said computer(s) can only be reset by at least one authorized security person who boards the vehicle after any threat to a vehicle or to persons aboard a vehicle has been eliminated and the vehicle is deemed safe and secure by authorized security personnel.

32. The system of claim 1 further comprising said onboard computer(s) having at least one ‘false deployment’ software routine that provides for a resetting of the computer(s) from said automated mode to an non-automated mode.

33. The system of claim 28 wherein said ‘false deployment’ software routine(s) can only be executed within a pre-determined time limit following a setting of said computer(s) to said automated mode.

34. The system of claim 28 wherein said at least one ‘false deployment’ software routine can only be executed within a pre-determined limited time period of less than 10 minutes after said computer(s) is set to said automated mode.

35. The system of claim 34 wherein said ‘false deployment’ software routine(s) can only be executed after said computer(s) is set to said automated mode and following the reception of subsequent secure electronic signal sent from a plurality of transmitters operated by vehicle-personnel aboard said vehicle.

36. The system of claim 35 wherein said ‘false deployment’ software routine(s) can only be executed when said subsequent secure electronic signal sent from a plurality of transmitters are received by said computer(s) within a pre-determined time period of less than 10 seconds.

37. The system of claim 1 further comprising:
at least one secure facility independent of said vehicle, having at least one secure-signal facility-transmitter for transmitting secure signal to said vehicle,
said vehicle having at least one vehicle-receiver for receiving transmitted secure-signal sent from said secure facility,
said vehicle-receiver(s) having a communications link with said computer(s), and the combination of said computer(s) and software running thereon responsive to said secure signal to effect the transportational mode of said vehicle.

38. The system of claim 37 further comprising said computer(s) having at least one ‘false deployment’ software routine that can only be executed following the reception of a secure electronic signal sent from said facility-transmitter to said vehicle-receiver.

39. The system of claim 37 further comprising said computer(s) having at least one software routine for selecting at least one automated vehicle route in response to the reception of a secure electronic signal sent from said facility-transmitter to said vehicle-receiver.

40. The system of claim 1 further comprising said computer(s) having at least one software routine for selecting at least one automated vehicle route in response to the reception of a secure electronic signal sent from said transmitter(s) to said vehicle-receiver(s).

41. The system of claim 37 further comprising said computer(s) having at least one software routine for selecting at least one vehicle destination in response to the reception of a secure electronic signal sent from said facility-transmitter to said vehicle-receiver.

42. The system of claim 1 further comprising said computer(s) having at least one software routine for selecting at least one vehicle destination in response to the reception of a secure electronic signal sent from said transmitter(s) to said vehicle-receiver(s).

43. The system of claim 37 wherein said secure electronic signal transmits encrypted data and said system is further comprised of onboard decryption means to decrypt said encrypted data.

44. The system of claim 1 wherein said secure electronic signal of said transmitter(s) transmits encrypted data and said system is further comprised of onboard decryption means to decrypt said encrypted data.

45. The system of claim 1 further comprising:
at least one secure facility independent of said vehicle, having at least one secure-signal facility-transmitter for transmitting secure signal to said vehicle;
said vehicle having at least one vehicle-transmitter suitable for establishing a communications link with a facility-receiver at said facility;
said vehicle having at least one vehicle-receiver for receiving transmitted secure-signal sent from said secure facility; and
said computer(s) having at least one software routine responsive to said secure electronic signal when sent from said secure-signal facility-transmitter to said vehicle-receiver to effect the transportational mode of said vehicle.

46. The system of claim 1 further comprising:
at least one secure facility independent of said vehicle, having at least one secure-signal facility-transmitter for transmitting secure signal to said vehicle;
said vehicle having at least one vehicle-transmitter suitable for establishing a communications link with a facility-receiver at said facility;
said vehicle having at least one vehicle-receiver for receiving transmitted secure-signal sent from said secure facility;
said vehicle and said facility(s) having bi-directional voice communication means for conducting voice communications between at least one person at said secure facility(s) and at least one person aboard said operating vehicle; and
said computer(s) having at least one software routine responsive to said secure electronic signal when sent from said secure-signal facility-transmitter to said vehicle-receiver to effect the transportational mode of said vehicle.

47. The system of claim 1 further comprising:
at least one secure facility independent of said vehicle, having at least one secure-signal facility-transmitter for transmitting secure signal to said vehicle;
said vehicle having at least one vehicle-transmitter suitable for establishing a communications link with a facility-receiver at said facility;
said vehicle having at least one vehicle-receiver for receiving transmitted secure-signal sent from said secure facility;
said vehicle and said facility(s) having bi-directional voice communication means for conducting voice communications between at least one person at said secure facility(s) and at least one person aboard said operating vehicle;
said secure facility(s) having voice-stress analysis system capable of providing voice-stress analysis of said person(s) aboard said operating vehicle and reporting atypical stress in the human voice; and
said computer(s) having at least one software routine responsive to said secure electronic signal having data pertaining to said voice-stress analysis when sent from said secure-signal facility-transmitter to said vehicle-receiver to effect the transportational mode of said vehicle.

48. The system of claim 46 wherein said bi-directional voice communication is limited to a pre-determined time period of less than 10 contiguous minutes to preclude any attempt by at least one hijacker aboard a vehicle to negotiate a desired outcome.

49. The system of claim 46 wherein said communication between at least one person at a secure ground-based facility and at least one person aboard an operating vehicle is further comprised of a video imaging means for transmitting live video of said at least one person aboard an operating vehicle.

50. The system of claim 37 wherein said secure facility has security provided by at least one branch of the military.

51. The system of claim 1 wherein said at least one computer is a flight management computer “FMC.”

52. The system of claim 1 wherein said at least one computer is a flight management system “FMS.”

53. The system of claim 1 wherein each of said at least one path is a navigational route programmable in and executable by said computer(s).

54. The system of claim 53 wherein at least one of said navigational route(s) ends at a destination.

55. The system of claim 1 wherein said vehicle is an aircraft and each of said at least one path is a flight vector programmable in and executable by said computer(s).

56. The system of claim 1 wherein said vehicle is an aircraft and each of said at least one path is a flight vector programmable in and executable by said computer(s) and at least one of said vectors(s) ends on a runway of an airport and said at least one automated mode is an automated safe landing of said aircraft.

57. The system of claim 55 wherein at least one of said flight vectors(s) ends at a destination away from any highly populated area.

58. The system of claim 1 wherein each of said at least one path is a railroad route programmable in and executable by said computer(s).

59. The system of claim 1 wherein said computer(s) is programmed to fly an aircraft at a safe altitude and along a safe course in the event of a depressurization of the aircraft cabin.

60. The system of claim 1 further comprising said transmitter(s) having voice transmission means to send at least one voice activation signal to said receiver(s) and the receiver(s) having voice-recognition and analog to digital conversion means to convert said signal into data that can be executed by said computer(s).

61. The system of claim 1 further comprising a vehicle-transmitter capable of sending a vehicle-status signal to at least one independent facility, wherein at least one of said facility(s) is equipped to grant s “top priority status” to the moving vehicle to clear all other like vehicles out of its way on any route said vehicle takes and to any destination it goes to, and said facility is also equipped with communications means to contact any transportation-related and security entity to notify them of the vehicle's status.

62. The system of claim 1 further comprising said computer(s) being programmed to automatically set a vehicle into an automated mode if said vehicle is diverted from a expected path for longer than a predetermined threshold time period and when no communication from the vehicle has been made during said time period.

63. The system of claim 1 further comprising said computer(s) being programmed to automatically set a vehicle into an automated mode if said vehicle is not sending transponder signal for longer than a predetermined threshold time period and when no communication from the vehicle has been made during said time period.

64. The system of claim 1 further comprising:
said vehicle having at least one orifice and coupling means for coupling one end of a gas conduit thereto;
a supply of at least one incapacitating gas having a gas outlet and coupling means for coupling an opposite end of said gas conduit thereto; and
control means for controlling the flow of said gas through said conduit into said vehicle as needed.

65. The system of claim 1 further comprising:
said computer(s) being programmed to, and having a user interface to provide for, the entering of a transportation mode change access code to revert said computer(s) from an automated mode to a non-automated mode when a crew member controlling the vehicle is convinced after conferring with a plurality of vehicle personnel that a “false deployment” mistakenly sent by at least one vehicle personnel has caused the vehicle to enter an automated mode.

66. The system of claim 1 further comprising:
said computer(s) being programmed to, and having a user interface to provide for, the entering of a transportation mode change access code to revert said computer(s) from an automated mode to a non-automated mode when a crew member controlling the vehicle is convinced that a “false deployment” mistakenly sent by at least one vehicle personnel has caused the vehicle to enter an automated mode, and
said system further comprising said computer(s) being programmed to automatically set said vehicle back into an automated mode if said vehicle is diverted from a expected path for longer than a predetermined threshold time period and when no communication from the vehicle has been made during said time period.

67. A system for preventing the hijacking, or suicide-bombing, of a transportation vehicle equipped with at least one onboard computer capable of operating said vehicle in an automated transportational mode along at least one path, said system comprising:
at least one signal receiver interfaced with, and having a communication link with, said computer(s);
said computer(s) configured to be responsive to at least one secure signal when initiated by at least one user and sent from at least one signal transmitter to said signal receiver(s);
said transmitter(s) having an easy-to-use user-interface which is operated by an engagement of at least one digit of a user's hand to cause said signal to be sent to said receiver(s);
said computer(s) having at least one software routine which is enabled when said signal is received by said receiver(s) and which causes the computer to operate the vehicle in at least one automated mode.

68. A method for preventing the hijacking, or suicide-bombing, of a transportation vehicle equipped with at least one onboard computer capable of operating said vehicle in an automated transportational mode along at least one path, said method comprising the steps of:
a) entering vehicle path data and vehicle destination data into said computer(s) before said vehicle departs;
b) equipping the vehicle with at least one signal-receiver interfaced with, and having a communication link with, said computer(s) such that said computer(s) is configured to be responsive to at least one secure signal when initiated by at least vehicle personnel-user and sent from at least one signal transmitter to said signal receiver(s);
c) equipping a plurality of said vehicle personnel-users with said transmitter(s) having an easy-to-use user-interface during a time of emergency;
d) operating said transmitters as needed by an engagement of at least one digit of a user's hand to cause said signal to be sent to said receiver(s);
e) equipping said computer(s) with at least one software routine which is enabled when said signal is received by said receiver(s) and which causes the computer to operate the vehicle in at least one automated mode; and
f) transmitting vehicle transportation mode status to proper authorities when a vehicle enters a system-automated mode.

69. The method of preventing said vehicle hijacking and suicide-bombing of claim 67 further comprising the steps of:
a) audibly informing those aboard said vehicle that the vehicle is equipped with a computerized vehicle control system capable of safely controlling the vehicle in case of an emergency,
b) audibly informing those aboard that if any attempt to overtake or divert the vehicle is made or suspected, or threat of harm to any vehicle-personnel is made or suspected, all manual control of the vehicle will be disabled and the vehicle will be directed to automatically and safely go to at a pre-determined destination. After stopping, the vehicle will remain disabled and cannot be moved until authorized security personnel board the vehicle, remove any security threat, remove everyone from the vehicle, and after the vehicle is emptied, manually reset the vehicle computer.

70. The method of preventing said vehicle hijacking and suicide-bombing of claim 67 further comprising the steps of:
a) informing those who intend to board said vehicle in writng that the vehicle is equipped with a computerized vehicle control system capable of safely controlling the vehicle in case of an emergency,
b) informing those who intend to board said vehicle in writng that if any attempt to overtake or divert the vehicle is made or suspected, or threat of harm to any vehicle-personnel is made or suspected, all manual control of the vehicle will be disabled and the vehicle will be directed to automatically and safely go to at a pre-determined destination. After stopping, the vehicle will remain disabled and cannot be moved until authorized security personnel board the vehicle, remove any security threat, remove everyone from the vehicle, and after the vehicle is emptied, manually reset the vehicle computer.
